(19) United States
(12) Patent Application Publication
(10) Pub. No.: US 2009/0007205 A1
(43) Pub. Date: Jan. 1, 2009

(54) USER TERMINAL AND PROXY SERVER OF INTERNET PROTOCOL TELEVISION (IPTV) SYSTEM, AND OPERATING METHOD THEREOF

(75) Inventors: Dae-hyun LEE, Seoul (KR); Chun-un KANG, Seoul (KR); Seung-hyuk YOO, Seoul (KR); Young-jun KIM, Seoul (KR); Ki-won KWAK, Seongnam-si (KR); Min-woo JUNG, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/971,422

(22) Filed: Jan. 9, 2008

(30) Foreign Application Priority Data
Jun. 26, 2007 (KR) 10-2007-0063160

(51) Int. Cl. H04N 7/173

(52) U.S. Cl. 725/110

(57) ABSTRACT

A user terminal and proxy server of an Internet Protocol Television (IPTV), and an operating method thereof are provided. A user terminal of an IPTV system includes a channel information input unit which receives channel information as an input, a channel management unit which transmits the input channel information to a proxy server, and receives from the proxy server a content information that corresponds to the channel information, and a content playback unit which replays a content using the received content information. As a result, viewers can use IPTV contents as easily as they use general TVs.

### CROSS-REFERENCE TO RELATED APPLICATIONS

This application claims priority from Korean Patent Application No. 2007-0063160, filed on Jun. 26, 2007, the entire content of which is incorporated herein by reference.

### BACKGROUND OF THE INVENTION

1. Field of the Invention

Devices and methods consistent with the present invention relate to a user terminal and proxy server of an Internet Protocol Television (IPTV), and an operating method thereof, and more particularly, to a user terminal and a proxy server of an IPTV system capable of providing content without having to process multiple stages of operations, and an operating method thereof.

2. Description of the Related Art

Terrestrial wave, cable and satellite broadcasting are currently available for TV, but researchers continue to work on new types of TV services that use the Internet.

IPTV is a system that delivers TV content and services over the Internet. IPTV can be defined as broadcasting service that is available on not only the current legacy network, but also the next generation network (NGN).

FIG. 1 illustrates a structure of channel listings in a related art IPTV.

Referring to FIG. 1, a related art IPTV generally employs a tree structure of channel listings, in which menus are linked with each other in a hierarchical structure. With this structure, a user selects menus to view content.

Levels 0 to 3 are menu nodes, and level 4 is a content node. As mentioned above, menu nodes are linked with each other in a tree structure, and provide navigation function. The content node is at the lowest end of the tree structure, and it provides content for viewing.

In order to view the content, a user selects a menu from level 0. As the user moves through the menus and pages by selecting certain menus, he reaches the node at the lowest end, and as a result, views the content played back. In other words, the user can view the content only after he makes selections of menus from level 0 to level 4 in sequence.

In the channel listings of a related art IPTV, only a limited number of content is addable to the initial menu structure. In order to add a new content of a new category to the initial categories of menus, it is necessary to re-structure the menu itself, so the user does not have much freedom to change or add new program to the menus.

Additionally, the channel listing of the related art IPTV does not provide any support for the guarantee for service quality of the channels.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

It is an aspect of the present invention to provide a user terminal and proxy server of a Internet Protocol Television (IPTV) capable of playing back a content of an intended channel without having to go through multiple stages, by using the proxy server as an intermediate medium between the user terminal and a content providing server, and an operating method thereof.

According to an aspect of the present invention, there is provided an IPTV system, including: a channel information input unit which receives channel information, a channel management unit which transmits the input channel information to a proxy server, and receives from the proxy server a content information that corresponds to the channel information, and a content playback unit which replays a content using the received content information.

The content information may include extended Really Simple Syndication (RSS) information.

The channel management unit may include a content information analysis unit which converts the received content information into data format usable at the channel management unit.

The channel management unit may include a grade control unit which controls viewing acceptability of the content, using grade information included in the received content information.

The content playback unit may receive the content from the content providing server, using an address of the content providing server included in the content information.

The proxy server may include a closed channel management unit which communicates with verified content providing servers in channels, and an open channel management unit which communicates with unverified content providing servers in channels, and the channel management unit may transmit the channel information to one of the closed channel management unit and the open channel management that corresponds to the input channel information.

According to another aspect of the present invention, there is provided an operating method of a user terminal of an IPTV system, including receiving channel information, transmitting the input channel information to a proxy server, receiving from the proxy server a content information that corresponds to the channel information, and playing back a content using the received content information.

The content information may include extended RSS information.

The operating method may further include converting the received content information into a usable data format.

The operating method may further include controlling viewing acceptability of the content, using grade information included in the received content information.

The playing back may include receiving the content from the content providing server, using an address of the content providing server included in the content information.

According to still another aspect of the present invention, there is provided a proxy server of an IPTV system, including a closed channel management unit which communicates with verified content providing servers in channels, and upon receiving channel information from a user terminal, which transmits the received channel information to a corresponding one among the verified content providing servers, and which receives content information from the content providing server, and an open channel management unit which communicates with unverified content providing servers in channels, and upon receiving channel information from the user terminal, which transmits the received channel information to a corresponding one among the unverified content providing servers, and which receives content information from the content providing server.

The proxy server may further include a channel management unit which manages all the registered channel information.

The closed channel management unit may include a cache unit which temporarily stores the content being provided by the verified content providing servers.

The content information may include extended RSS information.

The closed channel management unit and the open channel management unit may convert the received content information into extended RSS information.

The closed channel management unit and the open channel management unit may transmit the converted extended RSS information to the user terminal.

The extended RSS information may include channel identity (ID), content playback item information, navigation manner, player list of playback contents, grade information, genre, content address, paging information to construct section from one channel, or presence of mini channel.

According to still another aspect of the present invention, there is provided an operating method of a proxy server of an IPTV system, including receiving channel information from a user terminal, and transmitting the received channel information to a corresponding one among a plurality of content providing servers, receiving content information from the content providing server, and transmitting the received content information to the user terminal.

The content information may include extended RSS information.

The operating method may further include converting the received content information into extended RSS information, and wherein the transmitting comprises transmitting the converted extended RSS information.

The extended RSS information may include channel ID, content playback item information, navigation manner, player list of playback contents, grade information, genre, content address, paging information to construct section from one channel, or presence of mini channel.

### BRIEF DESCRIPTION OF THE DRAWINGS

The above and other aspects and features of the present invention will become more apparent by describing certain exemplary embodiments of the present invention with reference to the accompanying drawings, in which:

FIG. 1 illustrates a structure of channel listings of a related art IPTV;

FIG. 2 is a block diagram of a user terminal according to an exemplary embodiment of the present invention;

FIG. 3 is a block diagram of a user terminal according to another exemplary embodiment of the present invention;

FIG. 4 is a block diagram of a proxy server according to an exemplary embodiment of the present invention;

FIG. 5 is a view to explain information transmission and reception of an IPTV system according to an exemplary embodiment of the present invention;

FIG. 6 is a flowchart to explain an operating method of a user terminal according to an exemplary embodiment of the present invention; and

FIG. 7 is a flowchart to explain an operating method of a proxy server according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

Certain exemplary embodiments of the present invention will now be described in greater detail with reference to the accompanying drawings.

The matters defined in the description, such as detailed constructions and elements, are provided to assist in a comprehensive understanding of the embodiments of the present invention and are merely exemplary. Accordingly, those of ordinary skill in the art will recognize that various changes and modifications of the exemplary embodiments described herein can be made without departing from the scope and spirit of the present invention. Descriptions of well-known functions and constructions are omitted for clarity and conciseness.

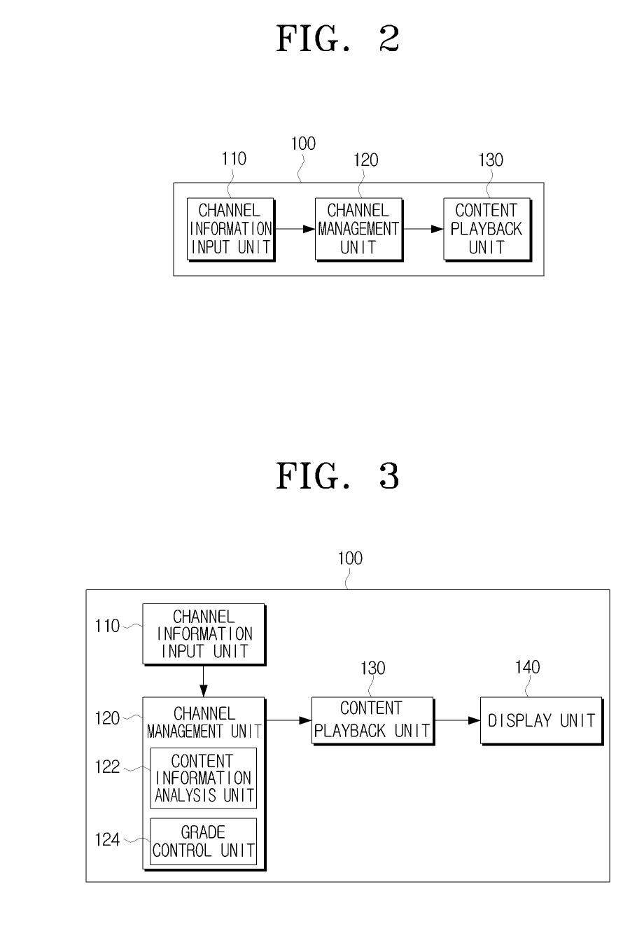

FIG. 2 is a block diagram of a user terminal according to an exemplary embodiment of the present invention.

Referring to FIG. 2, a user terminal 100 includes a channel information input unit 110, a channel management unit 120, and a content playback unit 130.

The channel information input unit 110 receives channel information about a content that a user intends to view. The channel information may be input through a remote controller or function keys provided to the user terminal 100.

The channel management unit 120 transmits channel information input from the channel information input unit 110 to a proxy server which will be explained below. The channel management unit 120 also receives content information from the proxy server. The content information corresponds to the channel information being transmitted to the proxy server.

Using the content information received from the proxy server by the channel management unit 120, the content playback unit 130 receives a content from a content providing server and replays the received content.

FIG. 3 is a block diagram of a user terminal according to another exemplary embodiment of the present invention.

Referring to FIG. 3, the user terminal 100 includes a channel information input unit 110, a channel management unit 120, a content playback unit 130, and a display unit 140. The user terminal 100 of FIG. 3 has the similar structure as that of the user terminal 100 illustrated in FIG. 2, and throughout the description set forth below, the same or like elements will be referred to as the same reference numerals.

The channel information input unit 110 receives channel information about a channel that a user intends to view. The channel information input unit 110 provides functions of channel selection and change, by enabling channel up/down or direct input of channel number through the remote controller or the function keys of the user terminal 100.

The channel management unit 120 transmits the channel information input from the channel information input unit 110 to the proxy server, so as to be provided with a content that corresponds to the channel intended by the user.

The channel management unit 120 receives content information from the proxy server. The content information corresponds to the channel information received by the channel management unit 120 from the proxy server.

The exemplary embodiment set forth below exemplifies that the channel management unit 120 receives from the proxy server the extended RSS information as the content information. The extended RSS information refers to a general RSS information added with functions. Therefore, the extended RSS information in this exemplary embodiment basically includes all the generally known RSS information.

The extended RSS information then may additionally include information such as channel ID, content playback item information, navigation manner, player list of playback contents, grade information, genre, content address, paging information to construct section from one channel, or presence of mini channel. Table 1 below lists additional functions to the extended RSS information.

TABLE 1

| Items | Details |
|---|---|
| chid | Channel information (number) |
| play_default | Content playback item information |
| navigation | Navigation manner such as manner of moving |
| | direction keys |
| player_compliance | Player list of playback contents |
| tv-rating | Content grades (e.g. Adult-only, teens acceptable, |
| | or kids acceptable) |
| tv-genre | Genre such as action, comedy, drama, etc. |
| original | Content address |
| page | Paging information to construct section from one |
| | channel |
| container | Capability for adding other mini channels |
| mini | Availability for being included as mini channel in |
| | other channels |

The “mini channel” is a subscreen displayed on a main screen in a relatively reduced size. Therefore, “container” indicates whether the current channel is able to include other mini channels thereon, and “mini” indicates whether the current channel can be included on other channels as a mini channel.

The channel management unit 120 includes a content information analysis unit 122, and a grade control unit 124.

The content information analysis unit 122 converts content information received from the proxy server into data format usable at the channel management unit 120. The converted data format may be Asynchronous Javascript And Xml (AJAX).

The grade control unit 124 controls viewing acceptability of the content, using the grade information, such as “tv-rating”, included in the extended RSS information of the content information. For example, the grade control unit 124 may allow content to be played back only after a predetermined verification process that requires entry of password, when the content is acceptable only for adult viewing.

The content playback unit 130 replays content using content information received through the channel management unit 120. That is, the content playback unit 130 receives content from a content providing server and replays the content, using an address, that is, “original” of the extended RSS information, of the content providing server which is included in the content information. The content playback unit 130 may include an image viewer, a motion picture player, a file viewer, and other TV players.

The display unit 140 displays images played back by the content playback unit 130, or information that the channel management unit 120 intends to provide to the user.

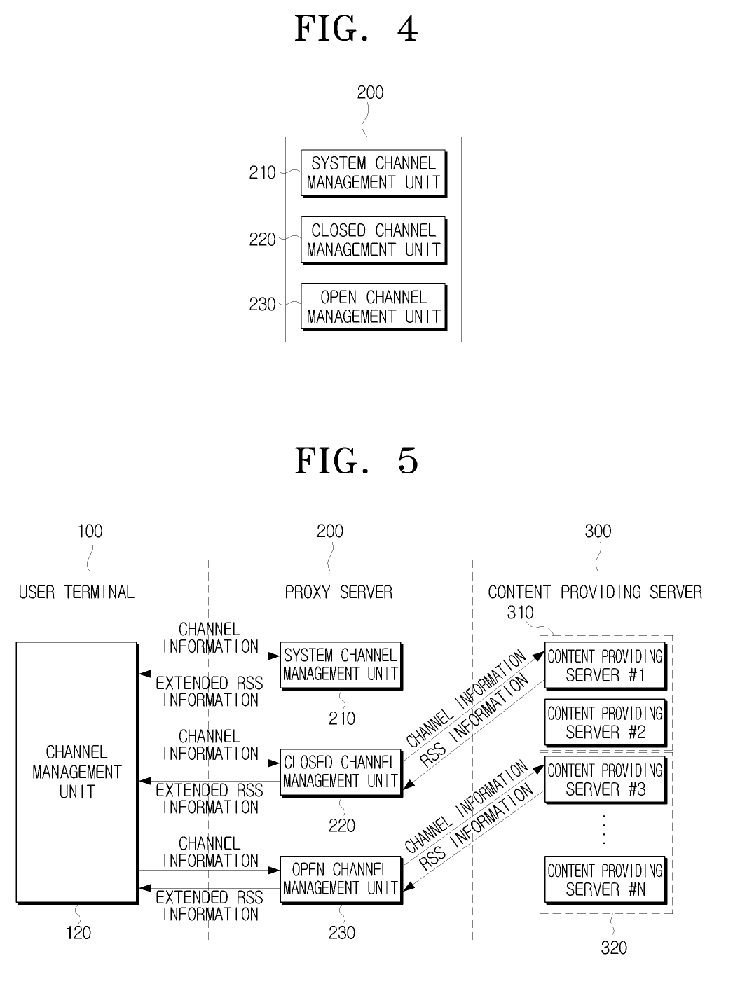

FIG. 4 is a block diagram of a proxy server according to an exemplary embodiment of the present invention.

Referring to FIG. 4, the proxy server 200 includes a system channel management unit 210, a closed channel management unit 220, and an open channel management unit 230.

The system channel management unit 210 manages the entire pre-registered channel information. The system channel management unit 210 also manages the user terminal 100 such as TV or settop box of the user.

The closed channel management unit 220 communicates with verified content providing servers 310 in the channel. When channel information is received from the channel management unit 120 of the user terminal 100, the closed channel management unit 220 transmits the received channel information to a corresponding one among the verified content providing servers 310, and receives content information from the verified content providing server 310.

RSS information may be provided from the verified content providing server 310 as content information, in which case the closed channel management unit 220 converts the RSS information received from the verified content providing server 310 into extended RSS information. The closed channel management unit 220 transmits the converted extended RSS information to the channel management unit 120 of the user terminal 100.

The closed channel management unit 220 guarantees Quality of Experience (QoE)/Quality of Service (QoS), by communicating with the previously verified content providing servers in a channel. The closed channel management unit 220 may temporarily store the content provided from the content providing server to ensure QoE/QoS.

Content providing servers registered in the closed channel management unit 220 are the ones that are previously verified by the manager. These verified servers ensure that services are provided through the closed channel management unit 220 that supports QoE/QoS, and that stable channels are provided.

The open channel management unit 230 communicates with unverified content providing servers 320 in the channel. When channel information is received from the channel management unit 120 of the user terminal 100, the open channel management unit 230 transmits the received channel information to a corresponding one among the received unverified content providing servers 320, and receives content information from the corresponding unverified content providing server 320.

The RSS information may be received as content information from the corresponding unverified content providing server 320, in which case the open channel management unit 230 converts the RSS information received from the unverified content providing server 320 into extended RSS information. The open channel management unit 230 then transmits the converted extended RSS information to the channel management unit 120 of the user terminal 100.

Content providing servers, which are not registered in the closed channel management unit 220, may participate in the channel through the open channel management unit 230. The user terminal 100 connecting with content providing servers 320 through the open channel management unit 230 thus knows that the corresponding content providing servers 320 are not registered ones and that he would not expect high quality service.

The open channel management unit 230 enables provision of a virtually unlimited number of contents available on the Internet to the viewers through the conversion into IPTV system channels, by participating all the unregistered content providing servers in the channel.

FIG. 5 is a view to explain information transmission and reception in an IPTV system according to an exemplary embodiment of the present invention.

The user terminal 100, upon receiving channel information through the channel information input unit 110, transmits channel information to the proxy server 200 through the channel management unit 120. The channel management unit 120 determines which of the system channel management unit 210, closed channel management unit 220, and open channel management unit 230 of the proxy server 200 manages the channel that the channel information input through the channel information input unit 110 belongs to, and transmits the channel information to the corresponding management unit 210, 220, or 230.

Upon receiving channel information from the channel management unit 120, the system channel management unit 210, the closed channel management unit 220, and the open channel management unit 230 provide the channel management unit 120 with the extended RSS information that corresponds to the input channel information.

The system channel management unit 210 responds to the transmission of the channel information of the channel management unit 120, thereby transmitting corresponding extended RSS information to the channel management unit 120. In this case, interaction with the content providing server 300 is unnecessary.

On the other hand, the closed channel management unit 220, or the open channel management unit 230 transmits channel information to one of content providing servers (#1 to #N), in response to channel information received from the channel management unit 120. The content providing server (#1 to #N) receiving the channel information from the proxy server 200 transmits content information, that is, transmits RSS information to the proxy server 200.

Upon receiving RSS information from the content providing server 300, the closed channel management unit 220, or the open channel management unit 230 converts the received RSS information into extended RSS information, and transmits it to the channel management unit 120.

In an exemplary embodiment of the present invention, it is exemplified that content providing servers (#1 and #2) are verified servers 310, and content providing servers (#3 to #N) are unverified servers 320. Verified content providing servers 310 are able to communicate with the closed channel management unit 220 in the channel, while unverified content providing servers 320 communicate with the open channel management unit 230 in the channel.

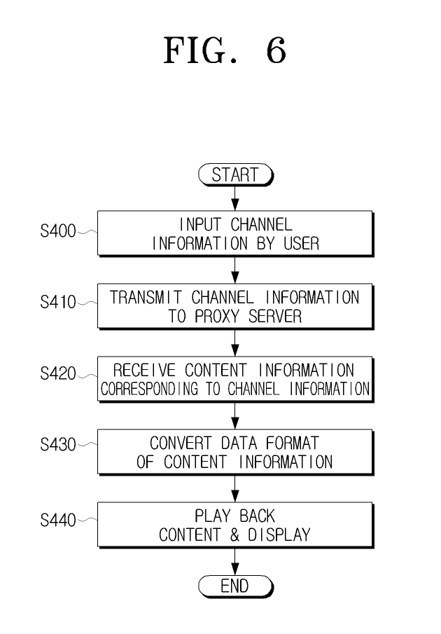

FIG. 6 is a flowchart to explain operating method of a user terminal according to an exemplary embodiment of the present invention.

In order to view TV, a user inputs channel number through a remote controller, or function keys provided on the user terminal 100. Accordingly, the channel information input unit 110 receives channel information input at operation S400.

At operation S410, the channel management unit 120 determines the management unit of the proxy server 200 that corresponds to the channel information input through the channel information input unit 110, and thus transmits the channel information to the corresponding one among the system channel management unit 210, closed channel management unit 220, and open channel management unit 230 of the proxy server 200.

The channel management unit 120, at operation S420, receives content information from one of the system channel management unit 210, closed channel management unit 220, and open channel management unit 230 that received the channel information. The content information may be extended RSS information.

Upon receiving content information from the proxy server 200, the content information analysis unit 122 at operation S430 analyzes the received content information, and converts it into data format usable at the channel management unit 120.

The channel management unit 120 controls the content playback unit 130 to replay corresponding content based on the content information. At operation S440, the content playback unit 130 receives a content from a corresponding content providing server 300 using the address of the content providing server 300 contained in the content information and replays the received content, and accordingly, the content is displayed on the display unit 140.

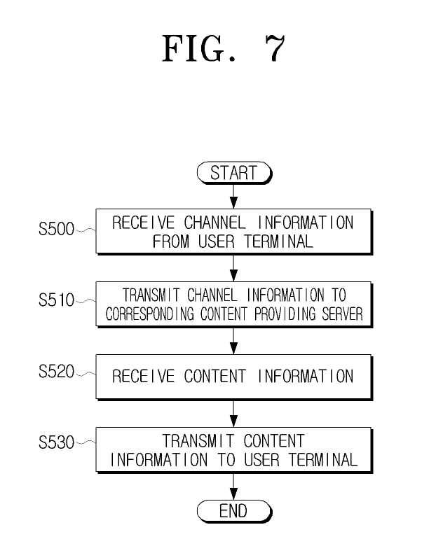

FIG. 7 is a flowchart to explain an operating method of proxy server according to an exemplary embodiment of the present invention.

The proxy server 200 includes a system channel management unit 210, a closed channel management unit 220, and an open channel management unit 230. The system channel management unit 210 is provided for the management of system channels. Accordingly, explanation below will focus on the case when the closed channel management unit 220 and the open channel management unit 230 receive channel information.

The closed channel management unit 220, or the open channel management unit 230 of the proxy server 200 receives channel information from the channel management unit 120 of the user terminal 100 at operation S500.

Upon receiving channel information from the channel management unit 120, the closed channel management unit 220, or the open channel management unit 230 transmits the channel information to the content providing server 300 that corresponds to the received channel information. At operation S510, the closed channel management unit 220 transmits channel information to the verified content providing servers 310, and the open channel management unit 230 transmits channel information to the unverified content providing servers 320.

At operation S520, the closed channel management unit 220, or the open channel management unit 230 receives content information from the content providing server 300 that transmits the channel information. The content information may be RSS information.

At operation S530, the closed channel management unit 220, or the open channel management unit 230 converts the RSS information received from the content providing server 300 into extended RSS information, and transmits it to the channel management unit 120 of the user terminal 100.

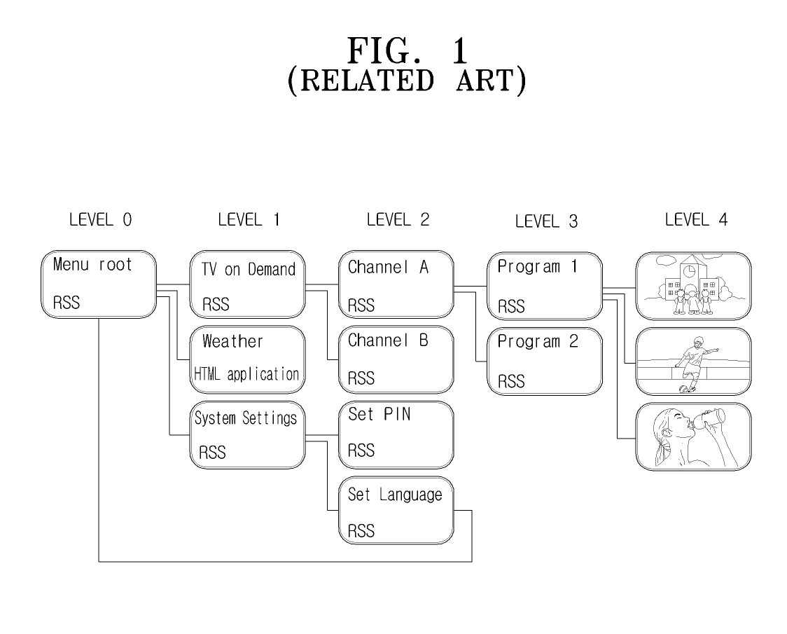

As explained with reference to FIGS. 6 and 7, the user terminal 100 is capable of receiving intended content by simply inputting channel information, and without having to go through multiple stages of menu selection as illustrated in FIG. 1.

As explained above, a user terminal and proxy server of an IPTV system, and an operating method according to the exemplary embodiments of the present invention employs the proxy server as an intermediate medium between the user terminal and content providing server, so that content of intended channel is played back without having to go through multiple stages. As a result, menu structure of complex structure is not required, and viewers can use content as easily as they use general TVs.

Furthermore, because proxy server manages content providing servers according on whether the servers are verified or not, virtually unlimited number of internet contents can be converted into IPTV channel and provided through unlimited number of channels.

The foregoing embodiments are merely exemplary and are not to be construed as limiting the present invention. The present teaching can be readily applied to other types of apparatuses. The description of the exemplary embodiments of the present invention is intended to be illustrative, and not to limit the scope of the claims. Many alternatives, modifications, and variations will be apparent to those skilled in the art.

What is claimed is:

1. A user terminal of an Internet Protocol Television (IPTV) system, comprising:
a channel information input unit which receives channel information;
a channel management unit which transmits the received channel information to a proxy server, and receives from the proxy server a content information that corresponds to the channel information; and
a content playback unit which replays a content using the received content information.

2. The user terminal of claim 1, wherein the content information comprises extended Really Simple Syndication (RSS) information.

3. The user terminal of claim 1, wherein the channel management unit comprises a content information analysis unit which converts the received content information into data format usable at the channel management unit.

4. The user terminal of claim 1, wherein the channel management unit comprises a grade control unit which controls viewing acceptability of the content, using grade information included in the received content information.

5. The user terminal of claim 1, wherein the content playback unit receives the content from a content providing server using an address of the content providing server included in the content information.

6. The user terminal of claim 1, wherein the proxy server comprises a closed channel management unit which communicates with verified content providing servers in channels, and an open channel management unit which communicates with unverified content providing servers in channels, and
the channel management unit transmits the channel information to one of the closed channel management unit and the open channel management that corresponds to the input channel information.

7. An operating method of a user terminal of an Internet Protocol Television (IPTV) system, comprising:
receiving channel information;
transmitting the received channel information to a proxy server;
receiving, from the proxy server, a content information that corresponds to the channel information; and
playing back a content using the received content information.

8. The operating method of claim 7, wherein the content information comprises extended Really Simple Syndication (RSS) information.

9. The operating method of claim 7, further comprising converting the received content information into a usable data format.

10. The operating method of claim 7, further comprising controlling viewing acceptability of the content, using grade information included in the received content information.

11. The operating method of claim 7, wherein the playing back comprises receiving the content from a content providing server, using an address of the content providing server included in the content information.

12. A proxy server of an Internet Protocol Television (IPTV) system, comprising:
a closed channel management unit which communicates with verified content providing servers in channels; and
an open channel management unit which communicates with unverified content providing servers in channels,
wherein, upon receiving channel information from a user terminal, the closed channel management unit transmits the received channel information to a corresponding verified content providing server among the verified content providing servers and receives content information from the corresponding verified content providing server, and
wherein upon receiving channel information from the user terminal, the open channel management unit transmits the received channel information to a corresponding unverified content providing server among the unverified content providing servers and receives content information from the corresponding unverified content providing server.

13. The proxy server of claim 12, further comprising a channel management unit which manages the channel information.

14. The proxy server of claim 12, wherein the closed channel management unit comprises a cache unit which temporarily stores the content being provided by the verified content providing servers.

15. The proxy server of claim 12, wherein the content information comprises extended Really Simple Syndication (RSS) information.

16. The proxy server of claim 15, wherein the closed channel management unit and the open channel management unit convert the received content information into the extended RSS information.

17. The proxy server of claim 16, wherein the closed channel management unit and the open channel management unit transmit the converted extended RSS information to the user terminal.

18. The proxy server of claim 16, wherein the extended RSS information comprises channel identity (ID), content playback item information, navigation manner, player list of playback contents, grade information, genre, content address, paging information, or presence of mini channel.

19. An operating method of a proxy server of an Internet Protocol Television (IPTV) system, comprising:
receiving channel information from a user terminal, and transmitting the received channel information to a corresponding content providing server among a plurality of content providing servers;
receiving content information from the corresponding content providing server; and
transmitting the received content information to the user terminal.

20. The operating method of claim 19, wherein the content information comprises extended Really Simple Syndication (RSS) information.

21. The operating method of claim 20, further comprising converting the received content information into the extended RSS information,
and wherein the transmitting comprises transmitting the converted extended RSS information.

22. The operating method of claim 21, wherein the extended RSS information comprises channel identity (ID), content playback item information, navigation manner, player list of playback contents, grade information, genre, content address, paging information, or presence of mini channel.
